(19) United States
(12) Patent Application Publication
(10) Pub. No.: US 2015/0044644 A1
(43) Pub. Date: Feb. 12, 2015

(54) Training Apparatus and Method for Language Learning

(71) Applicant: SHEPHERD DEVELOPMENT LLC., Kaohsiung City (TW)

(72) Inventor: Ming-Wei Hsu, Kaohsiung City (TW)

(73) Assignee: SHEPHERD DEVELOPMENT LLC., Kaohsiung City (TW)

(21) Appl. No.: 13/964,311

(22) Filed: Aug. 12, 2013

(51) Int. Cl. G09B 19/06

(52) U.S. Cl. CPC G09B 19/06
USPC 434/157

(57) ABSTRACT

A training method for language learning is provided, which includes: building user data of a user in a storage unit; retrieving target contents from a CTC database to a UTC database of the storage unit in accordance with difficulty levels of the target contents and the acquired level; setting a test by selecting test contents of the target contents in the UTC database as questions of the test; scoring the user's answers to the questions; performing an AL adjustment for the acquired level in accordance with a score of the test; performing a DL adjustment for the difficulty levels in accordance with correctness of each answer to the respective question in the test; and uploading the target contents with changed difficulty levels to the CTC database to update the target contents in the CTC database.

### BACKGROUND OF THE INVENTION

1. Field of the Invention

The present invention generally relates to a training apparatus and method for language learning. More particularly, the present invention relates to a language training apparatus and method with an adaptive acquired level scheme.

2. Description of the Related Art

In the last few decades, language training apparatuses are used to improve the language development skills such as word recognition, vocabulary, and sentence and paragraph comprehension of students. For instance, in word recognition, the way to help a student by a language training apparatus is providing the student with materials such as a group of key words classified at a first level, scoring a test about these key words the student taking, and further feeding the student with another group of key words classified at a higher, second level if this student get a score high enough in the test. Therefore, the higher level the student achieves, the greater skill in word recognition the student has. An example of this kind of training apparatuses is disclosed in U.S. Pat. No. 7,150,630. However, the training apparatuses operated by the above scheme may have the following drawbacks.

First, the conventional training apparatuses cannot automatically adjust the materials provided to the student according to the learning situation of this student. Although a conventional training apparatus may determine whether this student is qualified for a next level or not, the materials corresponding to each level are not arranged by an actual situation of the background of this student, but by the editor of this training apparatus.

Second, the conventional training apparatuses are unable to find out and improve a student's weaknesses in language learning. It is an often situation that some specific words or sentence patterns usually regarded as low-level contents are extremely hard to a high-level student. However, since the tests taken by a student are usually corresponding to the present level of this student, those low-level but confusing contents may be neglected and become blind sides of the student once he/she is promoted to the next level without a full understanding of all the key words at the original level. Besides, the conventional training apparatus do not automatically check whether a student still remembers and can correctly use the contents learned weeks, months or years ago unless this student keeps reviewing what he has learned and taking the low-level testes to make sure, which is absolutely a time-wasting job for a high-level student.

Third, the conventional training apparatuses are unable to provide students with a gradual learning schedule. Normally, although all key words in the database of a conventional language training apparatus are classified into several levels for students to learn step by step, the result of the first test taken by a student just promoted to a new level is usually not well enough, which may lead to diffidence in language learning of the student.

As a result, it is necessary to improve the conventional language training apparatuses.

### SUMMARY OF THE INVENTION

It is therefore the objective of this invention to provide a training method for language learning with an adaptive acquired level scheme to adaptively and automatically pick out target contents suitable to a user in accordance with his/her learning situation in a target language.

One embodiment of the invention discloses a training method for language learning, which includes: checking whether user data of a user exist in a storage unit by a processing unit of a remote device, and building the user data with an acquired level if the storage unit does not have the user data; retrieving target contents from a CTC database to a UTC database of the storage unit in accordance with difficulty levels of the target contents and the acquired level, wherein a corresponding group of each difficulty level has a common item identical to an item in the user data; setting a test by the remote device to select test contents of the target contents in the UTC database as questions of the test; scoring answers to the questions of the test by the remote device, wherein the answers are provided by the user; performing an AL adjustment for the acquired level in accordance with a score of the test; performing a DL adjustment for the difficulty levels in accordance with correctness of each answer to the respective question in the test; and uploading the target contents with changed difficulty levels obtained by the DL adjustment to the CTC database to update the target contents in the CTC database.

In a preferred form shown, the target contents retrieved from the CTC database have difficulty levels equal to the acquired level.

In a preferred form shown, the target contents retrieved from the CTC database are identified as in a first group and a second group, the target contents in the first group have difficulty levels equal to the acquired level, and the target contents in the second group have difficulty levels unequal to the acquired level.

In the preferred form shown, the test is set with 10% of test materials of the test from the test contents of the target contents in the second group.

In a preferred form shown, the UTC database includes a present target section and a previous target section, the present target section stores the retrieved target contents, and the previous target section stores target contents that are originally stored in the present target section and shifted from the present target section before the target contents from the CTC database are newly retrieved.

In the preferred form shown, the test is set with 70% of test materials of the test from the test contents of the target contents in the present target section and 30% of the test materials from the test contents of the target contents in the previous target section.

In a preferred form shown, the AL adjustment includes: increasing the acquired level when the score is higher than a qualified standard, decreasing the acquired level when the score is lower than an acceptable standard, or maintaining the acquired level when the score falls between the qualified and acceptable standards, wherein the qualified standard is higher than the acceptable standard.

In a preferred form shown, the DL adjustment includes: decreasing any one of the difficulty levels if a question in the test is correctly answered, wherein the decreased difficulty level corresponds to the target contents regarding to said correct-answered question, and increasing any one of the difficulty levels if a question in the test is incorrectly answered, wherein the increased difficulty level corresponds to the target contents regarding to said incorrect-answered question.

In a preferred form shown, the target contents are updated by: calculating a balance of positive and negative changes of an uploaded difficulty level, lifting this difficulty level of the target contents in the CTC database if the balance is higher than a positive threshold value, and lowering this difficulty level of the target contents in the CTC database if the balance is lower than a negative threshold value.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is a block diagram illustrating a system structure of a training apparatus for language learning according to a preferable embodiment of the invention.

FIG. 2 is a block diagram illustrating operation steps of a training method for language learning according to the preferable embodiment of the invention.

FIG. 3 is a flowchart of the training method for language learning according to the preferable embodiment of the invention.

In the various figures of the drawings, the same numerals designate the same or similar parts.

### DETAILED DESCRIPTION OF THE INVENTION

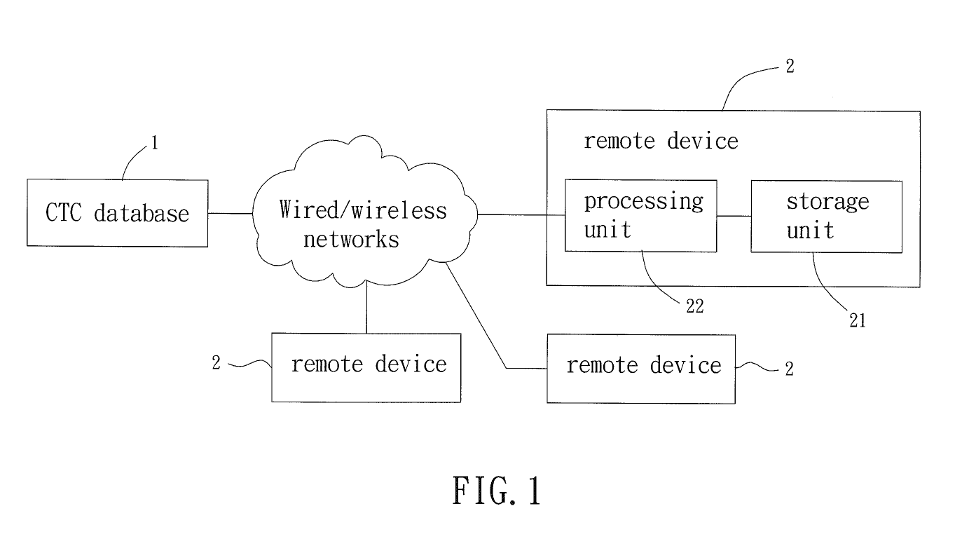

Referring to FIG. 1, a preferred embodiment of a training apparatus for language learning of the present invention is shown, which includes a Congregated Target Content database 1 (CTC database) and a plurality of remote devices 2. The CTC database 1 can be formed by at least one cloud server and stores target contents including teaching and test contents accessible to the remote devices 2. The remote devices 2 can be formed by electronic devices capable of communication such as cell phone, tablet PC, laptop computer or desktop computer. The remote devices 2 electrically connect with the CTC database 1 via wired and/or wireless networks to download data from or upload data to the CTC database 1, wherein each remote device 2 has a storage unit 21 and a processing unit 22. The storage unit 21 is adapted to store user data and a master program, and the storage unit 21 also serves as a User's Target Content database (UTC database) to store target contents downloaded from the CTC database 1. The processing unit 22 runs the master program and uses the information in the storage unit 21 to dominate a training method for language learning performed via this training apparatus.

Specifically, the user data in the storage unit 21 include a user name representing a user, an acquired level (AL) of the user, and information about the user such as items including his/her first language, citizenship, age and level of education. Specifically, the acquired level represents the user's level in a target language in which the target contents stored in the CTC database 1 display, such as English, Chinese or French. For instance, the information of the user can be built as “Chinese (native language), Taiwan (citizenship), 5-10 (age), elementary school (level of education), Asia (living area),” and the acquired level can be “2.”

Each datum in the target contents has an academic part and a level part. For teaching contents, the academic part includes a teaching material, such as the definition, pronunciation and example sentences of a key word or a lecture about a specific topic; for test contents, the academic part includes a question, such as a reading question or an aural question. The level part includes at least one difficulty level (DL), which shows the difficulty of the teaching material or the question to a group of people with at least one common item such as their first language, citizenship, age or level of education. Specifically, the said group of people corresponding to one of the difficulty level is defined as a corresponding group of this difficulty level hereinafter. For instance, the level part of each one of the retrieved target contents is a series of numbers, while each number serves as a difficulty level whose corresponding group has a common item, such as people using Chinese, English, French, German, Japanese or Korean as their first language or people living in Africa, America, Asia, Australia or Europe. Accordingly, with the level part accompanying the academic part, it is easy to recognize the difficulty of the teaching material or question of the academic part to a group of people with the same first language or citizenship, or having similar ages or levels of education.

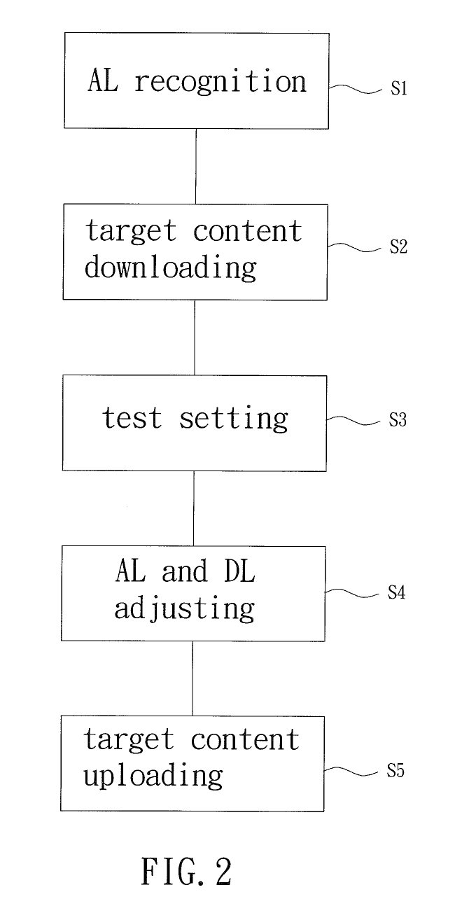

Referring to FIG. 2, a preferable training method for language learning is shown, which includes an AL recognition step S1, a target content downloading step S2, a test setting step S3, an AL and DL adjusting step S4, and a target content uploading step S5.

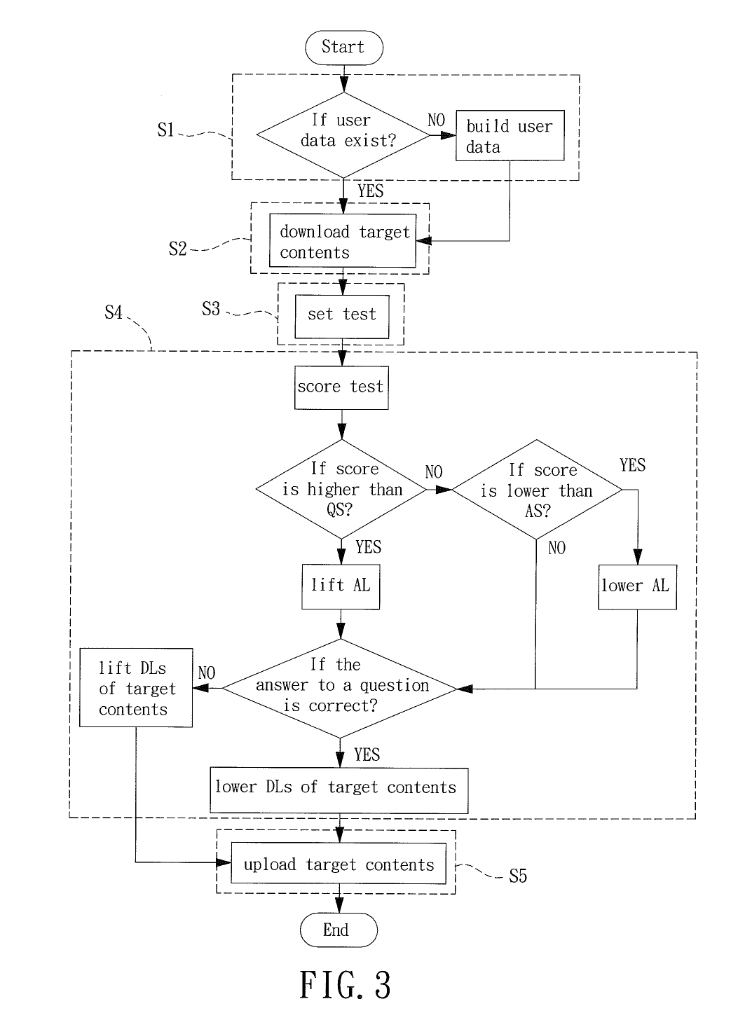

Referring to FIGS. 1 through 3, the AL recognition step S1 is executed by the processing unit 22 of a remote device 2 to recognize the acquired level of the user who is learning the target language via this remote device 2. Specifically, in the AL recognition step S1, the processing unit 22 checks whether the user data of the user with his/her acquired level exist in the storage unit 21 first. If there is the said user data in the storage unit 21, the processing unit 22 executes the target content downloading step S2 then. However, if this user is new to the remote device 2, that is, the user data with an acquired level of this user are absent in the storage unit 21, the processing unit 22 requires the user to create an user name as well as its information and retrieves a sample test from the CTC database 1, and then determines the user's acquired level by his/her score on this sample test, so as to build the user data of this user. Alternatively, the way to determine a new user's acquired level can also be executed by inserting a default value or a predetermined value set in accordance with an average of the acquired levels of a group of people having a common item identical to an item in the information of the user data.

After the acquired level of the user is recognized, the processing unit 22 executes the target content downloading step S2 to retrieve target contents from the CTC database 1 and to save the retrieved target contents in the UTC database, wherein the test contents of the retrieved target contents match the teaching contents thereof, such as both of the teaching and test contents regarding to the same key words. Preferably, the retrieved target contents can be identified as in first and second groups. Each datum of the target contents in the first group has a difficulty level, whose corresponding group has a common item identical to an item in the information of the user data, and which is equal to the acquired level in the user data. On the contrary, each datum of the target contents in the second group has a difficulty level, whose corresponding group also has a common item identical to an item in the information of the user data, but which is unequal to the said acquired level. For example, in a case that the target contents including the teaching and test contents of key words “telephone,” “dictionary,” “computer,” “simulation” and “architectonics” are retrieved, the target contents of “telephone,” “dictionary,” and “computer” having the same difficulty level equal to the acquired level “2” of the user, whose corresponding group has a common item identical to an item in the information of the user data, such as “Chinese (first language)” or “Asia (living area),” are identified as in the first group. On the other hand, the target contents of “simulation” and “architectonics” having difficulty levels higher than the acquired level “2” of the user, whose corresponding groups also have a common item identical to an item in the information of the user data, are identified as in the second group.

Furthermore, it is preferable that there are a present target section and a previous target section in the UTC database, so that the target contents newly retrieved from the CTC database 1 can be stored in the present target section after the target contents originally stored in the present target section are shifted to the previous target section. Specifically, the previous target section can also include a plurality of parts, so that the target contents can be sorted by time. For example, in the UTC database, the present target section stores the target contents newly retrieved from the CTC database 1, a first part of the previous target section stores the target contents retrieved by the target content downloading step S2 executed last time, and a second part of the previous target section stores all of the target contents retrieved before the last target content downloading step S2 is executed. Specifically, after the target content downloading step S2 is completed, all of the teaching contents stored in the UTC database are accessible to the user of the remote device 2 except for the teaching contents in the second group stored in the present target section.

The test setting step S3 is executable once the target content downloading step S2 is done, and the processing unit 22 may execute the test setting step S3 after receiving a testing request made by the user or right after the target content downloading step S2, so as to set a test for the user. All test materials for the questions of the test are selected from the test contents stored in the UTC database. In order to test the user's understanding of the newly retrieved teaching contents as well as to remind the user of the old target contents learned previously, it is preferable that said test materials include the test contents in the present target section and the previous target section. Besides, the test contents in the second group stored in the present target section is adapted to provide unexpected challenges for the user. For example, 70% of the test materials are from the test contents in the present target section and 30% of the test materials are from the test contents in the previous target section, such as 60% of the test materials from the first group of the newly retrieved target contents stored in the present target section, 10% of the test materials from the second group of the newly retrieved target contents stored in the present target section, 20% of the test materials from the target contents stored in the first part of the previous target section, and the other 10% of the test materials from those stored in the second part of the previous target section. As a result, since different users' acquired levels may be different and the target contents retrieved from the CTC database 1 by their remote devices 2 may also be different, the questions in the test for different users can be quite different at all, which totally matches the user's learning situation in the target language and thus can individually create a desirable and adaptable environment for every language learner.

The AL and DL adjusting step S4 is executed after the test set in the test setting step S3 is done by the user and the answers of the questions are scored by the processing unit 22. Preferably, in order to perform an AL adjustment in the AL and DL adjusting step S4, an acceptable standard (AS) and a qualified standard (QS) higher than the acceptable standard are previously set, and thus the acquired level of the user may be adjusted in accordance with the relationship among the score of the test and these two standards. Specifically, the acquired level of the user is lifted by at least one grade if the score is higher than the qualified standard; the acquired level of the user is maintained if the score falls between the qualified standard and acceptable standard; however, if the score is lower than the acceptable standard, the acquired level of the user is thus lowered by at least one grade.

Moreover, in the AL and DL adjusting step S4, a DL adjustment is also performed according to the correctness of every answer to a respective question in the test. Specifically, if the answer to a question in the test is correct, the difficulty levels are thus lowered, whose corresponding groups have a common item identical to an item in the information of the user data and which are shown by the level parts of the target contents regarding to this question; however, the said difficulty levels should be lifted if this question is incorrectly answered. For example, if the test contents of “telephone” serve as a question in the test and this question is wrongly answered, the difficulty levels of the teaching and test contents of this key word is thus lifted; contrarily, the difficulty levels of the teaching and test contents of this key word will be lowered if this question is answered correctly.

Finally, in the target content uploading step S5, the remote device 2 uploads the target contents stored in the UTC database and having adjusted difficulty levels to the CTC database 1, so as to accordingly update the target contents in the CTC database 1. Preferably, in order to perform the updating about the difficulty levels of the target contents in the CTC database 1, a difficulty level lifted by the remote device 2 is defined as having a positive change and a difficulty level lowered by the remote device 2 is defined as having a negative change. The CTC database 1 is capable of adding up the positive and negative changes of any one of the difficulty levels, which are provided by plural remote devices 2, so that the CTC database 1 can lift this difficulty level of the target contents in the CTC database 1 when the balance of the positive and negative changes of a difficulty level is higher than a positive threshold value, or the CTC database 1 can lower this difficulty level when the balance is lower than a negative threshold value. For instance, if the positive and negative threshold values are respectively set as “+3” and “−3” and four incorrect answers to a question about “simulation” are made by four people using Chinese as their first language, the balance of the positive and negative changes of a difficulty level corresponding to the group of people using Chinese as their first language has achieved “−4,” and thus the difficulty levels of the target contents of “simulation,” whose corresponding group consists of people speaking Chinese as their first language, are increased by one. However, in the above example, if three of the answers are incorrect but the other one is correct, the said difficulty levels are maintained since the balance of the positive and negative changes is “−2,” which is neither higher than the positive threshold value “3” nor lower than the negative threshold value “−3.”

In sum, with the above steps of the preferred embodiment, the language training apparatus can adaptively and automatically pick out target contents suitable to a user in accordance with his/her learning situation in the target language, and can also remind the user of the learned target contents by the questions selected from the test contents stored in the previous target section in the UTC database. Besides, even though a user is newly upgraded, there are still some easy and familiar materials in questions of the test, and thus the upgrading in the acquired level may not easily lead to diffidence in language learning. Furthermore, since the difficulty levels of the target contents respectively represents corresponding groups with different backgrounds and are adjusted automatically according to the old users' understandings in the teaching contents thereof, this language training apparatus can accurately provide suitable target contents to a new user who provides his/her background in detail.

Although the invention has been described in detail with reference to its presently preferable embodiments, it will be understood by one of ordinary skill in the art that various modifications can be made without departing from the spirit and the scope of the invention, as set forth in the appended claims.

What is claimed is:

1. A training method for language learning, comprising:
checking whether user data of a user exist in a storage unit by a processing unit of a remote device, and building the user data with an acquired level if the storage unit does not have the user data;
retrieving target contents from a CTC database to a UTC database of the storage unit in accordance with difficulty levels of the target contents and the acquired level, wherein a corresponding group of each difficulty level has a common item identical to an item in the user data;
setting a test by the remote device to select test contents of the target contents in the UTC database as questions of the test;
scoring answers to the questions of the test by the remote device, wherein the answers are provided by the user;
performing an AL adjustment for the acquired level in accordance with a score of the test;
performing a DL adjustment for the difficulty levels in accordance with correctness of each answer to the respective question in the test; and
uploading the target contents with changed difficulty levels obtained by the DL adjustment to the CTC database to update the target contents in the CTC database.

2. The training method for language learning as claimed in claim 1, wherein the target contents retrieved from the CTC database have difficulty levels equal to the acquired level.

3. The training method for language learning as claimed in claim 1, wherein the target contents retrieved from the CTC database are identified as in a first group and a second group, the target contents in the first group have difficulty levels equal to the acquired level, and the target contents in the second group have difficulty levels unequal to the acquired level.

4. The training method for language learning as claimed in claim 3, wherein the test is set with 10% of test materials of the test from the test contents of the target contents in the second group.

5. The training method for language learning as claimed in claim 1, wherein the UTC database includes a present target section and a previous target section, the present target section stores the retrieved target contents, and the previous target section stores target contents that are originally stored in the present target section and shifted from the present target section before the target contents from the CTC database are newly retrieved.

6. The training method for language learning as claimed in claim 5, wherein the test is set with 70% of test materials of the test from the test contents of the target contents in the present target section and 30% of the test materials from the test contents of the target contents in the previous target section.

7. The training method for language learning as claimed in claim 1, wherein the AL adjustment includes: increasing the acquired level when the score is higher than a qualified standard, decreasing the acquired level when the score is lower than an acceptable standard, or maintaining the acquired level when the score falls between the qualified and acceptable standards, wherein the qualified standard is higher than the acceptable standard.

8. The training method for language learning as claimed in claim 1, wherein the DL adjustment includes: decreasing any one of the difficulty levels if a question in the test is correctly answered, wherein the decreased difficulty level corresponds to the target contents regarding to said correct-answered question, and increasing any one of the difficulty levels if a question in the test is incorrectly answered, wherein the increased difficulty level corresponds to the target contents regarding to said incorrect-answered question.

9. The training method for language learning as claimed in claim 1, wherein the target contents are updated by: calculating a balance of positive and negative changes of an uploaded difficulty level, lifting this difficulty level of the target contents in the CTC database if the balance is higher than a positive threshold value, and lowering this difficulty level of the target contents in the CTC database if the balance is lower than a negative threshold value.
